(19) United States
(12) Patent Application Publication
(10) Pub. No.: US 2022/0326956 A1
(43) Pub. Date: Oct. 13, 2022

(54) PROCESSOR EMBEDDED WITH SMALL INSTRUCTION SET

(71) Applicant: TOKYO INSTITUTE OF TECHNOLOGY, Tokyo (JP)

(72) Inventors: Yuko Hara, Tokyo (JP); Kaoru Saso, Tokyo (JP); Mingyu Yang, Tokyo (JP)

(21) Appl. No.: 17/642,673

(22) PCT Filed: Sep. 17, 2020
(86) PCT No.: PCT/JP2020/035226

§ 371 Date: Mar. 11, 2022

(30) Foreign Application Priority Data
Sep. 24, 2019 (JP) 2019-172638

(51) Int. Cl. G06F 9/38; G06F 9/30

(52) U.S. Cl. CPC G06F 9/3836; G06F 9/3005; G06F 9/30029; G06F 9/30032

(57) ABSTRACT

Provided is a processor that is used for limited purposes such as preprocessing of raw data and that has a small circuit scale and high program processing efficiency, wherein an instruction block includes a 2-bit opcode. The processor can move to a branch destination or perform an operation by using an immediate bit accompanying the instruction block, by assigning a branch flag or an immediate instruction determination bit corresponding to the opcode.

### TECHNICAL FIELD

The present invention relates to a processor that includes an instruction set formed of fewer instructions than those in a conventional processor.

### BACKGROUND ART

Processors mounted in IoT devices are dominated by 32-bit processors. Typical 32-bit processors include Cortex (registered trademark)-M0, a micro-ripcy, and the like. Cortex-M0 is a small-size processor that has a register of 32 entries and that can process 60 instructions including 16-bit instructions and 32-bit instructions specified by different opcodes, and is used for various purposes (Non-patent Literature 1).

Moreover, the micro-riscy that is a small-size 32-bit processor is a processor that has a register of 16 entries and that has an instruction architecture of RISC-V capable of processing 45 16-bit instructions, and is used for various purposes (Non-patent Literature 2).

These processors include all arithmetic operations, memory accesses, branch instructions, and the like implemented in many existing processors.

Meanwhile, there is a demand for a processor used for limited purposes such as preprocessing of raw data such as measurement data and images. For example, such a processor is effective in processing of measurement data for medical diagnoses (processing of electrocardiographic waveform and the like).

Such a processor does not have to be capable of executing all functions included in the aforementioned general-purpose processors, but is desirably a processor that is small in size and that can perform the aforementioned raw data processing and the like in high efficiency. Accordingly, the processor used for limited purposes is desired to have a smaller circuit scale and higher processing speed than the general-purpose processors.

As a method of reducing the circuit scale and improving the processing speed of a processor, reducing the number of instructions included in the instruction set without reducing processing efficiency of software is conceivable. One instruction-set computer (OISC) (Non-patent Literature 3) is known as an instruction set architecture in which the number of instructions is very limited. Although many OISCs that can express any operation in one type of instruction and that are Turing-complete are proposed, the OISC has low actual application execution efficiency and is not suitable for practical use.

Moreover, since the OISC does not have a register file, an instruction format needs to be 32 bits×3=96 bits (in the case of three operands) to achieve a 32-bit processor and expression of instructions is also not efficient.

A minimum instruction-set computer (MISC) (Non-patent Literature 4) in which the number of instructions is increased from that in the OISC is also proposed.

Generally, the MISC refers to an instruction set architecture in which the number of instructions is 16 or 8 (32 at maximum). The research of the MISC was active around 1950. In those times, a circuit was implemented by using vacuum tubes and the concept of the architecture design thereof greatly differs from that of current circuit implementation using transistors. Specifically, a processor designed to improve “efficiency” around 1950 is not necessarily efficient in the current circuit implementation based on transistors.

A processor disclosed in Non-patent Literature 5 (hereinafter, referred to as “SubRISC”) has an instruction sets with fewer instructions than those in the conventional prior techniques, that is four types of instructions of subtraction (sub), logical AND (and), shift (sht), and memory access (mr, mw), and can efficiently execute these processes and also express any operation by combining these instructions. The SubRISC is a processor suitable for use in limited purposes such as preprocessing of measurement data. The instruction set of the SubRISC includes instruction sets with configurations shown in FIGS. 3A to 3C.

### CITATION LIST

### Non-Patent Literature

Non-patent Literature 1: https://en.wikipedia.org/wiki/ARM_Cortex-M#Cortex-M0
Non-patent Literature 2: P. D. Schiavone et al., “Slow and Steady Wins the Race? A Comparison of Ultra-Low-Power RISC-V Cores for Internet-of-Things Applications,” In Proceedings of International Symposium on Power and Timing Modeling, Optimization and Simulation (PATMOS), pp. 1-8, September 2017.
Non-patent Literature 3: https://en.wikipedia.org/wiki/One_instruction_set_computer
Non-patent Literature 4: https://en.wikipedia.org/wiki/Minimal_instruction_set_computer
Non-patent Literature 5: Kaoru Saso and Yuko Hara-Azumi, “Simple Instruction-Set Computer for Area and Energy-Sensitive IoT Edge Devices,” In Proceedings of International Conference on Application-specific Systems, Architectures and Processors (ASAP), pp. 93-96, July 2018.

### SUMMARY OF INVENTION

### Technical Problem

An object is to provide a processor that can be used for an application that performs relatively simple process such as preprocessing of data and that has an instruction set formed of a very small number of instructions and has a small size and high software processing efficiency.

### Solution to Problem

To solve the aforementioned problems, a processor of the invention of the present application has an instruction set formed of a subtraction instruction, a logical AND instruction, a left-right shift instruction, and a memory access instruction, and can cause a branch instruction or an immediate to accompany each of the subtraction instruction and the logical AND instruction.

### Advantageous Effects of Invention

The processor in the invention of the present application can execute instructions necessary for applications for preprocessing of data in IoT and the like and can have a smaller circuit scale and higher processing speed than a general-purpose processor.

### BRIEF DESCRIPTION OF DRAWINGS

FIG. 1A shows a format of a main block in an operation instruction of subtraction (sub) and logical AND (and) in a processor of an embodiment.

FIG. 1B shows a format of a branch block expressing a branch instruction in the processor of the embodiment (applied only to subtraction (sub) and logical AND (and)).

FIG. 10 shows a format of a main block in a shift instruction (shr, shl, sht) in the processor of the embodiment.

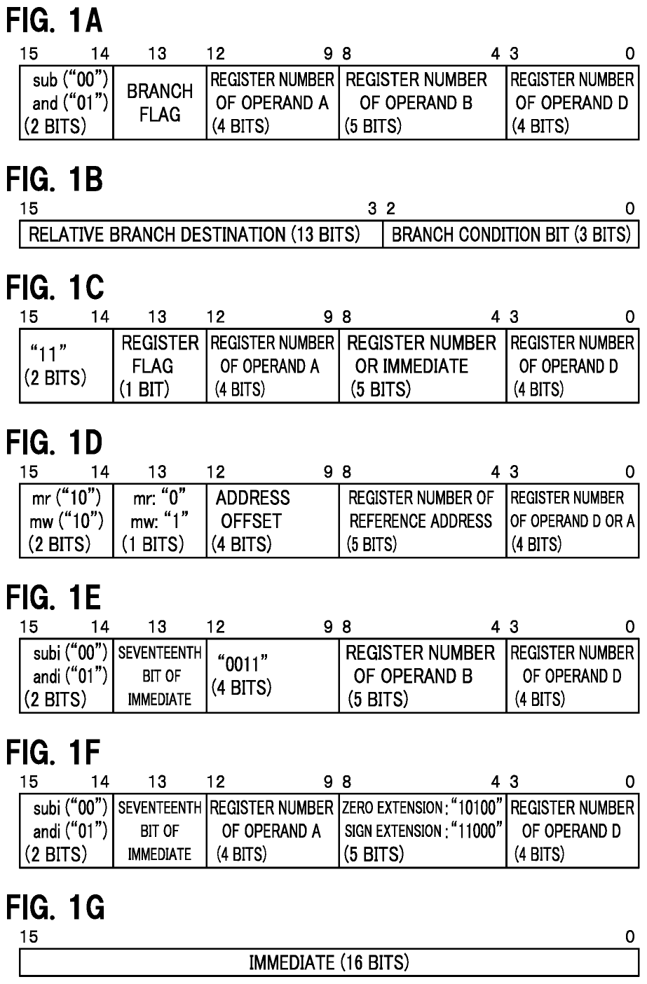

FIG. 1D shows a format of a main block in a memory access instruction (mr, mw) in the processor of the embodiment.

FIG. 1E shows a format of a main block in an operation instruction of subtract (subi) and logical AND (andi) handling an immediate in the processor of the embodiment (in the case of performing an operation of an operand B and the immediate).

FIG. 1F shows a format of a main block in an operation instruction of subtract (subi) and logical AND (andi) handling the immediate in the processor of the embodiment (in the case of performing an operation of the immediate and an operand A).

FIG. 1G shows a format of an immediate block indicating the immediate in the processor of the embodiment (always accompanies only subtraction (subi) and logical AND (andi) handling the immediate).

FIG. 2A shows a format of a main block in an instruction that is a right shift instruction (shr) in the processor of the embodiment and that causes values to be shifted to right by a fixed amount.

FIG. 2B shows a format of a main block in an instruction that is a left shift instruction (shl) in the processor of the embodiment and that causes values to be shifted to left by a fixed amount.

FIG. 2C shows a format of a main block in an instruction (sht) of shifting values in one of directions of left and right by a value stored in a register among shift instructions in the processor of the embodiment.

FIG. 3A shows a format of a main block in an operation instruction of subtraction (subt) and logical AND (and) and a shift instruction (sht) in a processor (SubRISC) of a conventional technique.

FIG. 3B shows a format of a branch instruction block in the processor (SubRISC) of the conventional technique (applies only to subtraction (sub), logical AND (and), and shift instruction (sht)).

FIG. 3C shows a format of a main block in a memory access instruction in the processor (SubRISC) of the conventional technique.

### DESCRIPTION OF EMBODIMENTS

A processor (hereinafter, also referred to as “SubRISC+”) of an embodiment is a 32-bit processor that includes 16 registers and that can perform a three-stage pipeline process, and has an instruction set formed of four types of instructions of subtraction (sub, subi), logical AND (and, andi), shift (shr, shl, sht), and memory access (mr, mw). This instruction set formed of instruction blocks with formats shown in FIGS. 1A to 1G. Each of the instruction blocks is a code formed of 16 bits.

The processor of the embodiment has the instruction set formed of four instructions that are far fewer than those in a processor used for general purpose. To this end, among the instructions in the instruction set of the processor used for general purpose, instructions used in complex arithmetic calculation and the like are omitted, and the instruction set in the processor of the embodiment includes only relatively-simple minimum instructions necessary for limited purposes such as preprocessing of data and is provided with functions for improving processing efficiency of a program.

Two bits of the fourteenth and fifteenth bits of a main block in each of the instructions shown in FIGS. 1A to 1G are formed of an opcode corresponding to a type of instruction corresponding to one of subtraction, logical AND, shift, and memory access, and is a main portion of the corresponding instruction. There are two types of operation instructions of subtraction and logical AND; one is an operation instruction (sub, and) that uses a constant and a value stored in a register; and the other is an operation instruction (subi, andi) that handles an immediate. A branch block and an immediate block accompany the main block depending on a condition and the length of instruction is 32 bit. The processor of the embodiment decodes and executes a program formed of a combination of the instructions of FIGS. 1A to 1G.

### <Subtraction and Logical AND>

FIG. 1A shows a format of a main block in an operation instruction of subtraction (sub) and logical AND (and) in the processor of the embodiment. The instruction with this format is an instruction for performing an operation between a number selected from predetermined constants and a 32-bit value stored in the register.

The two bits of the fourteenth and fifteenth bits of the main block are an opcode indicating subtraction (sub) or logical AND (and). When the opcode is “00”, the opcode indicates the operation instruction of subtraction and, when the opcode is “01”, the opcode indicates the operation instruction of logical AND.

“Register number of operand A” is a 4-bit code as shown in Table 1 and indicates a code corresponding to a constant 0, 1, or −1 (value expressed in 32 bits) to be set as the operand A (hereinafter, also referred to as “A”) or the number of the register in which the operand A being a 32-bit value is stored. Any of 12 types of register numbers from “0100” to “1111” can be specified as the number of register. The case where the “register number of operand A” is “0011” is the case where the operand A is to be an immediate. This case is the case where an operation of “subtraction or logical AND handling an immediate” to be described later is performed. In the instruction of performing the operation handling only a constant and a value stored in a register, the “register number of operand A” is never “0011”.

TABLE 1

| “Register number of | |
|---|---|
| operand A” | Operand A |
| 0000 | 0 |
| 0001 | 1 |
| 0010 | −1 |
| 0011 | Immediate |
| 0100 | Value stored in register with |
| ∥ | register number |
| 1111 | |

“Register number of operand B” is a 5-bit code as shown in Table 2 and indicates the number of a register in which an operand B (hereinafter, also referred to as “B”) being a 32-bit value is stored or a constant of 0, 1, or −1 (value expressed in 32 bits) corresponding to the operand B. Any of 16 types of numbers of “00000” to “01111” can be specified as the number of the register. When the “register number of operand B” is “10000” to “10010”, the operand B is a constant. There is a case where the operand B is an immediate. This case is the case where the operation of “subtraction or logical AND handling an immediate” to be described later is performed, and the “register number of operand B” is “10100” or “11000”. In the instruction of performing the operation handling only a constant and a value stored in a register, the “register number of operand B” is never “10100” or “11000”.

TABLE 2

| “Register number of | |
|---|---|
| operand B” | Operand B |
| 00000 | Value stored in register with |
| ∥ | register number |
| 01111 | |
| 10000 | 0 |
| 10001 | 1 |
| 10010 | −1 |
| 10100 | Immediate subjected to zero |
| | extension |
| 11000 | Immediate subjected to sign |
| | extension |

It is possible to specify 0, 1, and −1 that are constants with relatively high usage frequency as the operand A and the operand B. The processor of the embodiment can thereby achieve a shorter program and higher processing speed.

“Register number of operand D” indicates the number of a register in which an operand D (hereinafter, also referred to as “D”) being a 32-bit value is stored. A value obtained by an operation or the like is stored in this register.

When subtraction (sub) by the instruction with the format shown in FIG. 1A is executed, B-A=D that is a value obtained by subtracting A from B is calculated and D is stored in a register with a “register number of operand D”. When logical AND (and) of FIG. 1A is executed, the logical AND is calculated for each of bits of the 32-bit operand A and a corresponding bit of the 32-bit operand B. Specifically, when the corresponding bits of A and B are both “1”, the logical AND for these bits is “1” and, when at least one of the corresponding bits of A and B is “0”, the logical AND for these bits is “0”. The logical AND D of A and B obtained as a result is stored in the register with the “register number of operand D”.

FIG. 1B shows a format of a branch block expressing a branch instruction in the processor of the embodiment. Assume a case where the instruction with the format shown in FIG. 1A is either subtraction or logical AND. In this case, if a branch flag in the thirteenth bit in the main block of this instruction is “1”, a branch instruction block shown in FIG. 1B accompanies the instruction of the main block shown in FIG. 1A, and the instruction becomes a 32-bit instruction. If the branch flag in the thirteenth bit of the main block of the instruction with the format shown in FIG. 1A is “0”, no branch block of FIG. 1B accompanies the instruction of the main block and branching is not executed.

“Relative branch destination” formed of thirteen bits from the third bit to the fifteenth bit in the branch instruction block in FIG. 1B expresses a difference between a current branch instruction address and an instruction address of a branch destination. “Branch condition bits” formed of three bits from the zeroth bit to the second bit in the branch instruction block expresses a condition in branching. When the condition in the branching is satisfied, the program process moves to the branch destination. The branch condition is as follows.

When the main block is subtraction (sub), the branching is performed in the case of B−A<0 or |B|-|A|≤0. When the main block is logical AND (and), the branching is performed in the case where the least significant bit of a logical AND result value is “0”.

### <Shift>

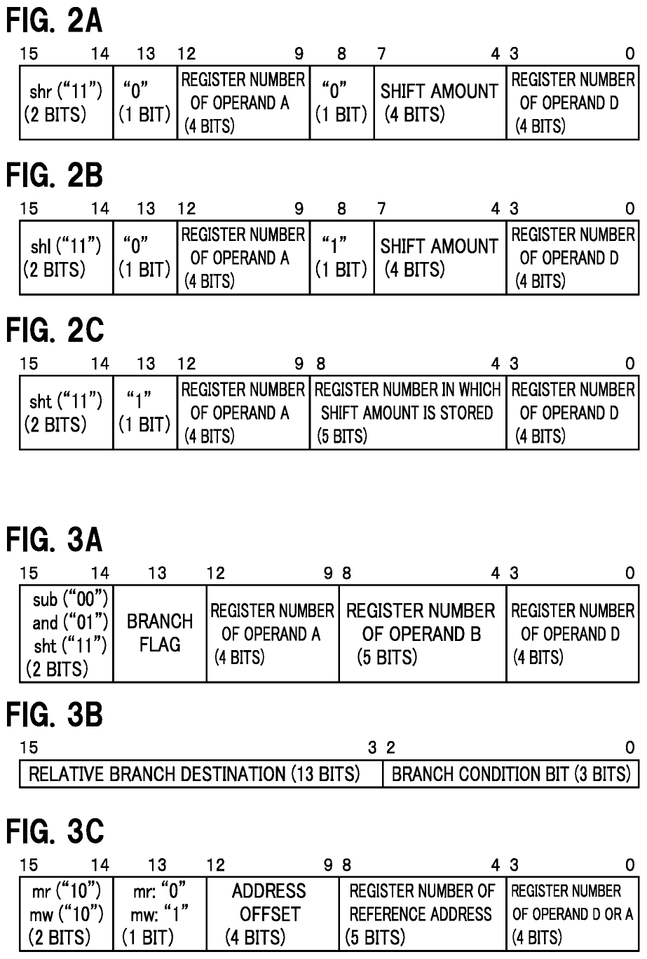

FIG. 10 shows a format of a main block in a shift instruction (shr, shl, sht) in the processor of the embodiment. The shift instruction is an instruction of shifting the values of the respective bits in target data in one of directions of left and right. The shift instruction of the embodiment includes an instruction (shr, shl) of shifting the values to left or right by using an immediate for shifting the values to left or right by a fixed amount and an instruction (sht) of shifting the values to left or right by a value stored in the register number. Two bits of the fourteenth and fifteenth bits in the main block are an opcode expressing shifting and is “11”. Data to be shifted is the operand A. The operand A is a value corresponding to the “register number of operand A” in Table 1. Five bits of “register number or immediate” in the fourth to eighth bits in the main block correspond to a bit number by which the values are to be shifted and the direction of the shifting. The bit number of shifting is set to the immediate or the value in the register with the “register number”, depending on a value of a register flag in the thirteenth bit in the main block. When this instruction is executed, the values of the respective bits of the operand A are shifted in one of directions of left and right by the predetermined bit number corresponding to the “register number or immediate”.

FIGS. 2A to 2C explain the format of the shift instruction in further detail. FIG. 2A shows a format of a main block in an instruction that is a right shift instruction (shr) in the processor of the embodiment and that causes value to be shifted to right by a fixed amount. FIG. 2B shows a format of a main block in an instruction that is a left shift instruction (shl) in the processor of the embodiment and that causes values to be shifted to left by a fixed amount. FIG. 2C shows a format of a main block in an instruction (sht) of shifting values in one of directions of left and right by a value stored in the register among the shift instructions in the processor of the embodiment.

FIGS. 2A and 2B are each the format of the main block in the shift instruction (shr, shl). The register flag in the thirteenth bit of the main block is “0”. This shift instruction (shr, shl) is an instruction of shifting the values in one of directions of left and right according to a direction and a shift amount specified by the immediate (fixed amount) formed of five bits from the fourth bit to the eighth bit in the main block. The eighth bit in the immediate indicates the direction of shifting. When the eighth bit is “0”, the instruction is right shift (shr) and, when the eighth bit is “1”, the instruction is left shift (shl). Moreover, four bits (hereinafter, expressed as arg[3:0]) from the fourth bit to the seventh bit in the immediate indicate the shift amount.

The shift amount is a bit number expressed by (shift amount)=8b+n (b and n are integers, 0≤b, n≤3). In this case, b=arg[3:2] (sixth and seventh bits in the main block) and n=arg[1:0] (fourth and fifth bits in the main block).

In the case of the right shift instruction (shr) (FIG. 2A), there is no further limitation for b and n. Meanwhile, in the case of the left shift instruction (shl) (FIG. 2B), limitations of 1≤b and n=0 (“00”) are added and the number of available shift amounts is smaller.

FIG. 2C is the format of the main block in the shift instruction (sht). The register flag in the thirteenth bit in the main block is “1”. The lower five bits (hereinafter, expressed as value[4:0]) in the 32-bit data stored in the register with the register number specified by the five bits of the fourth bit to the eighth bit in the main block determine the direction and amount of shifting.

The case where the value [4] is “0” indicates the right shifting and the case where the value [4] is “1” indicates the left shifting. The shift amount is determined by value[3:0].

As in the fixed amount shifting, the shift amount is the bit number expressed by (shift amount)=8b+n (b and n are integers, 0≤b, n≤3). In this case, b=value[3:2] and n=value [1:0].

In the case of the right shift instruction, there is no further limitation for b and n. Meanwhile, in the case of the left shift instruction, limitations of 1≤b and n=0 (“00”) are added and the number of available shift amounts is smaller.

The shift instruction in the instruction set of the processor in the invention of the present application uses the shifting by the fixed amount and the setting of the shift amount asymmetric in the left-right direction in which the left shift amount is limited, to achieve high speed and reduction of a circuit scale.

### <Memory Access>

FIG. 1D shows a format of a main block in memory access in the processor of the embodiment. A memory access instruction includes a memory read instruction (mr) and a memory write instruction (mw). Two bits of the fourteenth and fifteenth bits are an opcode and is “10”. When the thirteenth bit on the right of the opcode is “0”, the instruction is the memory read (mr) and, when the thirteenth bit is “1”, the instruction is memory write (mw). “Register number of reference address (five bits)” is the number of the register in which a reference address number in a memory is stored. “Address offset (four bits)” expresses an offset from the reference address number.

When the memory read (mr) is executed, a value stored in an address of the memory that is offset from the reference address of the memory by the “address offset (four bits)” is stored as the operand D in the register with the “register number of operand D” (zeroth to third bits), the reference address stored in the register with the “register number of reference address (five bits)”.

When the memory write (mw) is executed, the operand A (32 bits) stored in the zeroth to third bits is written in an address of the memory that is offset from the reference address of the memory by the “address offset (four bits)”.

### <Subtraction and Logical AND Handling Immediate>

FIGS. 1E and 1F shows formats of main blocks in operation instructions of subtract (subi) and logical AND (andi) handling the immediate in the processor of the embodiment. In each of these operations, one of the operand A and the operand B is set to the immediate that is a value described in the program. The instruction format of FIG. 1E is a format for performing an operation of the operand B and the operand A that is the immediate. The instruction format of FIG. 1F is a format for performing an operation of the operand A and the operand B that is the immediate. The opcode of the subtraction (subi) in FIGS. 1E and 1F is “00”, the opcode of the logical AND (andi) in FIGS. 1E and 1F is “01”, and these opcodes are the same as those in the instruction format of subtraction (sub) and logical AND (and) in FIG. 1A. FIG. 1G is an immediate block indicating the immediate in the processor of the embodiment. The immediate block always accompanies each of the main blocks in FIGS. 1E and 1F. As a result, these operation instructions have an instruction length of 32 bits.

In the operations of these instruction formats, operation operand of the operand A and the operand B is performed and the operand D obtained as a result is stored in the register with the “register number of the operand D” as in the instruction format of FIG. 1A. The operation instructions with the formats of FIGS. 1E and 1F greatly differ from the operation instruction with the format shown in FIG. 1A in that the one of the operand A and the operand B is set to the immediate and there is no branch instruction.

In the operation instruction that is shown in FIG. 1E and in which the operand A is set to the immediate, four bits from the ninth bit to the twelfth bit in the main block is “0011” as shown also in Table 1. When the four bits from the ninth bit to the twelfth bit in the main block of the operation instruction of subtraction and logical AND (subi, andi) are this code, the immediate block of FIG. 1G always accompanies this main block and the instruction becomes a 32-bit instruction.

In this case, the operand A is a 32-bit value that is a combination of 16 bits (zeroth bit to fifteenth bit) expressed by the immediate block and 16 bits (sixteenth bit to thirty-first bit) obtained by successively arranging 16 of a bit value of the “seventeenth bit of the immediate” in the thirteenth bit of the main block. Specifically, when the “seventeenth bit of the immediate” in the seventeenth bit of the main block is “0”, 16 bits from the sixteenth bit to the thirty-first bit are all set to “0” and, when the “seventeenth bit of the immediate” is “1”, 16 bits from the sixteenth bit to the thirty-first bit are all set to “1”.

In the operation instruction that is shown in FIG. 1F and in which the immediate is used as the operand B, five bits from the fourth bit to the eighth bit in the main block are “10100” or “11000” as shown also in Table 2. When the five bits from the fourth bit to the eighth bit in the main block of the operation instruction of subtraction and logical AND (subi, andi) are one of these codes, the immediate block of FIG. 1G always accompanies this main block.

When the five bits from the fourth bit to the eighth bit in the main block is “10100”, the operand B is set to a 32-bit value obtained by zero-extending the 16-bit immediate in the immediate block. In this case, 16 bits from the sixteenth bit to the thirty-first bit of the operand B are all “0”.

When the five bits from the fourth bit to the eighth bit in the main block is “10100”, the operand B is set to a 32-bit value obtained by sign-extending the 16-bit value in the immediate block. In this case, 16 bits from the sixteenth bit to the thirty-first bit of the operand B are all “1”.

Which one of the extension processes of the zero extension and the sign extension is to be performed on the operand B is selected for each program.

Unlike the SubRISC of the publicly known technique, the processor of the embodiment can perform an operation handling an immediate. This can make a program to be executed shorter and improve the processing speed.

Effects of the processor of the embodiment are described below.

A performance of a prototype processor SubRISC+ of the embodiment is described.

First, a circuit scale of the prototype processor is described. Comparison of circuit scale (μm² and the number of gates) between the SubRISC+ and processors of conventional techniques is shown in Table 3. The circuit area (μm²) is a result of designing each processor assuming that the power supply voltage is 0.75 V and the frequency is 50 MHz in Renesas SOTB 45 nm technology, and the number of gates is a value obtained by dividing the total area of processor cores by the area of 2-input NAND gates. The used design tool is Synopsys Design Compiler-F2011.09-SP2. The circuit scale correlates with the types of processable instructions. Accordingly, simplifying the instruction set and reducing the number of processable instructions can achieve reduction of the circuit area.

As can be seen from Table 1, the SubRISC of the publicly known technique and the processor SubRISC+ of the embodiment can have smaller circuit scales than the conventional general-purpose processors as a result of reducing the number of instructions and reducing the number of gates.

TABLE 3

| | Number of | Length of | | | Circuit | |
|---|---|---|---|---|---|---|
| | instruc- | instruc- | | Pipe- | Area | Number |
| Processor | tions | tions | Register | line | (μm²) | of gates |
| CORTEX- | 60 | 16/32 | 32 | 3 | 619.9k | 17.6k |
| M0 (Non- | | | entries | | | |
| patent | | | | | | |
| Literature 1) | | | | | | |
| MICRO- | 45 | 16 | 16 | 2 | 553.0k | 15.7k |
| RIPCY | | | entries | | | |
| (Non-patent | | | | | | |
| Literature 2) | | | | | | |
| SubRISC | 4 | 16 | 16 | 2 | 275.5k | 7.8k |
| | | | entries | | | |
| SubRISC+ | 4 | 16/32 | 16 | 3 | 311.0k | 8.9k |
| | | | entries | | | |

Next, processing performance is described. Each of the SubRISC+ and the processors of the conventional techniques are made to perform the following five types of processes of A to E and the processing time of each process is measured.

A. A process of arranging 5000 integer values in order with a quick sort algorithm.
B. A process of detecting 8×8 blocks that do not match from two 128×128 gray scale images.
C. A process of applying two-dimensional DCT conversion to a 48×48 gray scale image.
D. A process of creating a histogram of brightness values of pixels from a 64×64 gray scale image.
E. A process of applying a Laplacian contour detection filter to a 64×64 gray scale image.

The results are shown in Table 4. The processor SubRISC+ of the embodiment clearly has higher processing speed than the CORTEX-M0 used for general purpose and the SubRISC of the publicly known technique. This effect is due to higher program processing efficiency of the instruction set in the processor of the embodiment.

TABLE 4

| Processor | A | B | C | D | E |
|---|---|---|---|---|---|
| CORTEX-M0 | 1.9 | 0.19 | 0.11 | 0.12 | 0.36 |
| (Non-patent Literature 1) | | | | | |
| SubRISC (Non-patent Literature | 1.5 | 0.17 | N/A | N/A | N/A |
| 5) | | | | | |
| SubRISC+ | 1.2 | 0.14 | 0.09 | 0.06 | 0.34 |

The embodiment and expressions with conditions described in the present description are all given for the purpose of teaching the disclosed contents of the present description and the concepts of the invention by which the inventors of the present application have affected development of the conventional technique, in such a manner that a reader can easily understand these contents and concepts. The invention of the present application should not be interpreted to be limited to these embodiments and conditions. Although the embodiment of the present description is described in detail, various changes, alternatives, and modifications can be added to the embodiment without departing from the technical scope of the invention of the present application.

1. A processor in which an instruction block includes a 2-bit opcode, the processor being capable of moving to a branch destination or performing an operation by using an immediate bit accompanying the instruction block, by assigning a branch flag or an immediate instruction determination bit corresponding to the opcode.

2. The processor according to claim 1, wherein a subtraction instruction, a logical AND instruction, a left-right shift instruction, and a memory access instruction are assigned to the 2-bit opcode.

3. The processor according to claim 2, wherein a constant is specifiable as an operand in the instruction block of the subtraction instruction and the logical AND instruction.

4. The processor according to claim 2, wherein the immediate bit accompanies the instruction block when the immediate instruction determination bit is a predetermined value in the instruction block of the subtraction instruction and the logical AND instruction.

5. The processor according to claim 4, wherein a branch block that determines a branch condition and the branch destination accompany the instruction block when the branch flag is a predetermined value in the instruction block of the subtraction instruction and the logical AND instruction.

6. The processor according to claim 2, wherein the number of shift amounts to be specified by the shift instruction varies between left shifting and right shifting.

7. The processor according to claim 5, wherein the subtraction instruction, the logical AND instruction, the left-right shift instruction, and the memory access instruction
